(19) United States
(12) Patent Application Publication
(10) Pub. No.: US 2010/0091507 A1
(43) Pub. Date: Apr. 15, 2010

(54) Directed LED Light With Reflector

(75) Inventors: Wei Li, South Barrington, IL (US); Scott Carpenter, Elgin, IL (US)

Correspondence Address: NIXON PEABODY, LLP, 300 S. Riverside Plaza, 16th Floor, CHICAGO, IL, 60606, US

(73) Assignee: Opto Technology, Inc., Wheeling, IL (US)

(21) Appl. No.: 12/573,609

(22) Filed: Oct. 5, 2009

Related U.S. Application Data
(60) Provisional application No. 61/102,546, filed on Oct. 3, 2008.

(51) Int. Cl. B64D 47/02; F21V 1/00; F21V 9/00; F21V 7/00

(52) U.S. Cl. 362/470; 362/241; 362/231; 362/296.01; 362/294

(57) ABSTRACT

A high intensity light is disclosed. A first circular lighting array having a plurality of reflectors and light emitting diodes is provided. A second circular lighting array is mounted on the first circular lighting array. The second circular lighting array has a second plurality of reflectors and light emitting diodes. Each reflector includes a tulip-shaped reflective surface having a symmetrical vertical cross section and a different symmetrical horizontal cross section. The reflective surface creates a uniform beam reflecting from a corresponding LED at horizontal angles relative to the reflective surface and a narrow beam in vertical angles relative to the reflective surface.

### PRIORITY CLAIM

This application claims priority from U.S. Provisional Application No. 61/102,564 filed on Oct. 3, 2008 to the same inventors. That application is incorporated by reference in its entirety.

### FIELD OF THE INVENTION

The present invention relates to high intensity lights, and more specifically to an LED based high intensity obstruction light.

### BACKGROUND OF THE INVENTION

High intensity lights are needed for applications such as navigation beacons. For example, navigation lamps for aviation must be capable of meeting the 2,000 candela (cd) requirements for the U.S. Federal Aviation Authority (FAA) L864 standard and the International Civil Aviation Organization (ICAO) Medium Intensity Type B and Type C Navigation Lights standard. In the past such navigation lamps have used conventional strobe lights. However, strobe lights are energy and maintenance intensive. Recently, lamps have been fabricated using light emitting diodes (“LED”). LEDs create unique requirements in order to be commercially viable in terms of size, weight, price, and cost of ownership compared to conventional strobe lights, but are more energy efficient and require less maintenance.

The FAA and ICAO regulations set the following stringent requirements for beam characteristics at all angles of rotation (azimuth). Lights must have effective (time-averaged) intensity greater than 750 candela (cd) over a 3° range of tilt (elevation). Lights must also have peak effective intensity of 1,500-2,500 cd and effective intensity at −1° elevation of 750-1,125 cd for the ICAO only. In particular, the ICAO standard sets a very narrow “window” of beam characteristics at −1° of elevation which must be met by beams at all angles of rotation (azimuth).

In order to achieve the total light intensity required for an FAA or ICAO compliant light using LEDs, it is necessary to use a large number of LED based light sources. An example known high intensity obstruction light has three circular rows of LEDs and total internal reflection (TIR) lenses to achieve the required total illuminance and light beam uniformity. The number of rows increases the total height of the light engine, requiring a correspondingly taller enclosure, thereby increasing the total weight, height, and cost of the final obstruction light product.

However, it is difficult to create a beam with the desired intensity pattern when directing large numbers of LED light sources into few reflectors. Furthermore, smaller and therefore more numerous reflectors are needed to conform to overall size restrictions. These constraints all result in a design with a large number of optical elements comprised of individual LEDs and small reflectors. A final challenge is alignment of the multiple optical elements such that their outputs combine to form a beam which is uniform at all angles of azimuth.

Currently, available LED lamps simply stack multiple of optical elements symmetrically, as well as using complex TIR reflectors and multiple LEDs per reflector. Such complex reflectors require a solid plastic part with precise optical surfaces which is costly to mold. While compliant, such lamps require more than an optimal number of LEDs and thus are complex and expensive. A large number of LEDs requires a corresponding number of TIR lenses and LED circuit boards, all of which increase the cost of the light engine. The number of LEDs increases the electrical power required and the total heat which must be dissipated. Finally, the solid nature of the TIR lenses and the number of TIR lenses contribute to the total weight of the light engine, which can make installation of the final obstruction light product more difficult.

Thus there is a need for an efficient LED based lamp that meets FAA and ICAO standards. There is also a need for an LED lamp that allows the use of relatively smaller reflectors. There is a further need for an LED lamp that provides uniform light output.

### SUMMARY

One example relates to a high intensity light having a first circular lighting array having a plurality of reflectors and light emitting diodes. A second circular lighting array is mounted on the first circular lighting array. The second circular lighting array has a second plurality of reflectors and light emitting diodes. Each reflector includes a reflective surface having a symmetrical vertical cross section and a different symmetrical horizontal cross section to create a uniform beam reflecting from a corresponding LED at horizontal angles relative to the reflective surface and a narrow beam in vertical angles relative to the reflective surface.

Another example is an optical assembly for producing a uniform light beam reflected from a corresponding light source at horizontal angles and a narrow beam in vertical angles. The optical assembly has a support member mounted vertically having an exterior surface. A light emitting diode is mounted on the exterior surface of the support member. A reflector is mounted on the exterior surface of the base member. The reflector has a reflective surface including segments generated as parabolic curves joined to form a contiguous surface. The reflective surface has a vertical symmetry and a different horizontal symmetry.

Another example is an aircraft warning lamp having a first circular lighting array having a first plurality of optical elements emitting light at all horizontal angles and a narrow beam in vertical angles. A second circular lighting array has a second plurality of optical elements emitting light at horizontal angles and a narrow beam in vertical angles. The second plurality of optical elements is offset from the first plurality of optical elements. Each of the optical elements includes a light emitting diode and a reflector. The reflector has a reflective surface having a symmetrical vertical cross section and a different symmetrical horizontal cross section to create a uniform beam reflecting from a corresponding light emitting diode at horizontal angles relative to the reflective surface and a narrow beam in vertical angles relative to the reflective surface.

Additional aspects will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective diagram of an example LED high intensity light with optical elements having tulip shaped reflectors;

FIG. 2 is a perspective view of the interior components of the example LED high intensity light in FIG. 1;

FIG. 3 is a perspective view of a section having two optical elements each having an LED and a reflector of the high intensity light in FIG. 1;

FIG. 4 is a front view of a section of optical elements in FIG. 3;

FIG. 5 is a side view of a reflector of an optical element in FIG. 3;

FIG. 6 is a top view of a reflector of an optical element in FIG. 3;

FIG. 7 is a graph showing the side view of the calculated beam pattern from one of reflectors of the optical elements in FIG. 3;

FIG. 8 is a graph showing the top view of the calculated beam pattern from one of reflectors of the optical elements in FIG. 2;

FIG. 9 is a plot of measured intensity from a single LED and tulip-shaped reflector of the optical elements in FIG. 3 versus azimuth (horizontal) angle;

FIG. 10 is a plot of measured intensity from a single LED and tulip-shaped reflector of the optical elements in FIG. 3 versus elevation (vertical) angle;

FIG. 11 is a plot of calculated intensity for summation of multiple LEDs and reflectors of the optical elements of the high intensity light in FIG. 1 versus the azimuth angle; and

FIG. 12 is a plot of the calculated far-field intensity pattern in both elevation and azimuth for an optical element in FIG. 3.

While these examples are susceptible of embodiment in many different forms, there is shown in the drawings and will herein be described in detail preferred examples with the understanding that the present disclosure is to be considered as an exemplification and is not intended to limit the broad aspect to the embodiments illustrated.

### DETAILED DESCRIPTION

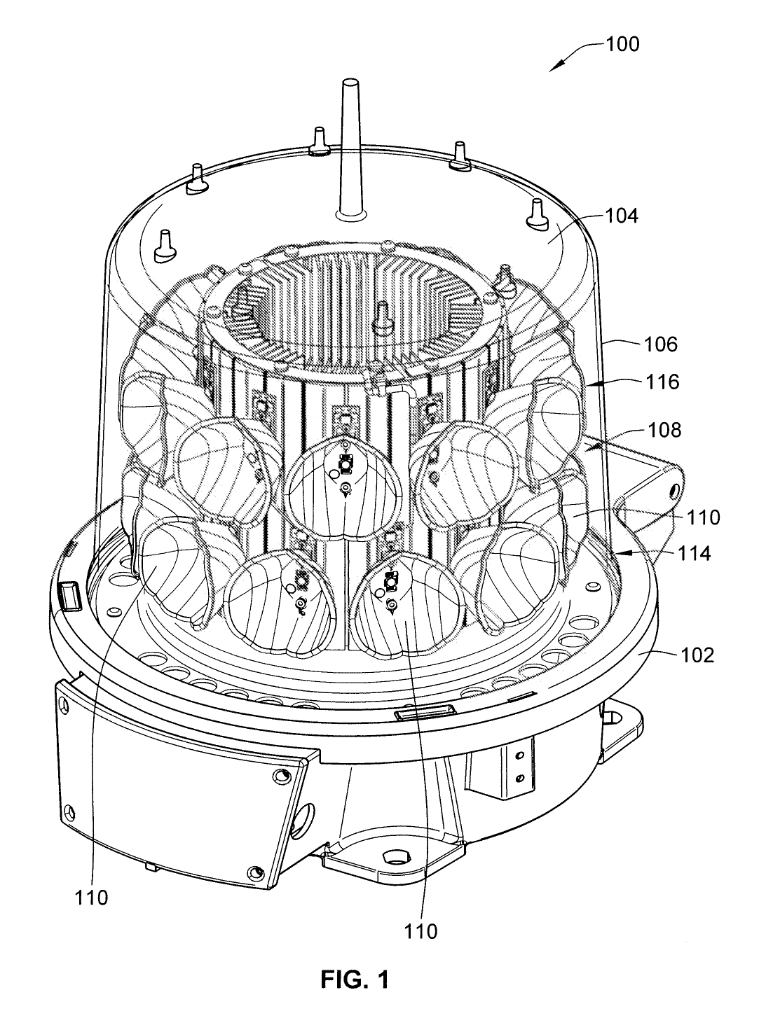

FIG. 1 shows the exterior of an example high intensity LED based lamp 100. In this example, the LED based lamp 100 may be used as an aircraft beacon obstruction light in accord with applicable FAA and ICAO standards. The high intensity LED based lamp 100 has a base 102, a top housing 104 and a transparent cylindrical housing 106. The base 102, top housing 104 and transparent cylindrical housing 106 enclose a lighting array 108 mounted on a base. The base 102 provides support and alignment for the lighting array 108 while allowing heat to be transferred from the LEDs in the lighting array 108 and power supplies (not shown) to the ambient surroundings. The base 102 includes various mounting mechanisms to allow the lamp 100 to be secured to a surface. The top housing 104 may include bird deterrent spikes. The cylindrical housing 106 is a generally cylindrical transparent housing which protects the optical elements on the lighting array 108 while allowing the transmission of light generated by the optical elements on the lighting array 108.

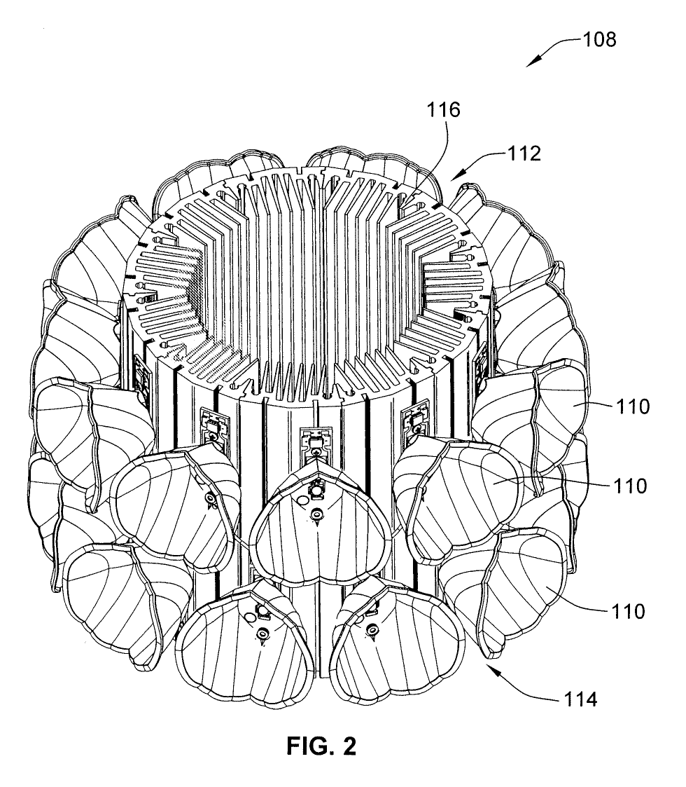

FIG. 2 is a perspective view of the lighting array 108 of the high intensity light 100 in FIG. 1 with the transparent cylindrical housing 106 removed. The lighting array 108 has a series of optical elements 110 that are arrayed in two circular lighting arrays 112 and 114 that will be detailed below. As shown in FIG. 2, the circular lighting arrays 112 and 114 are arrayed in a vertical stack with two rows of optical elements 110 each.

In the preferred embodiment, there are eleven optical elements 110 arrayed circumferentially in each of the circular lighting arrays 112 and 114, so the optical elements 110 are spaced at equal angular intervals of 360/11=32.7°. The optical elements 110 of the second circular light array 114 achieve the desired total intensity and to fill in the “gaps” (i.e., regions of low light intensity) from the first circular lighting array 112. In this example, the two circular light arrays 112 and 114 together form two rows with eleven optical elements 110 per row. The offset between the optical elements 110 in the two rows of the respective two circular light arrays 112 and 114 is 360/22=16.4°

In this example, the individual optical elements 110 have a pattern of beam intensity versus azimuth angle, which when combined with light from adjacent optical elements 110, produces total beam intensity with minimum ripple. Reflector designs could be further optimized so that the summation of intensities has even less ripple variation than illustrated here.

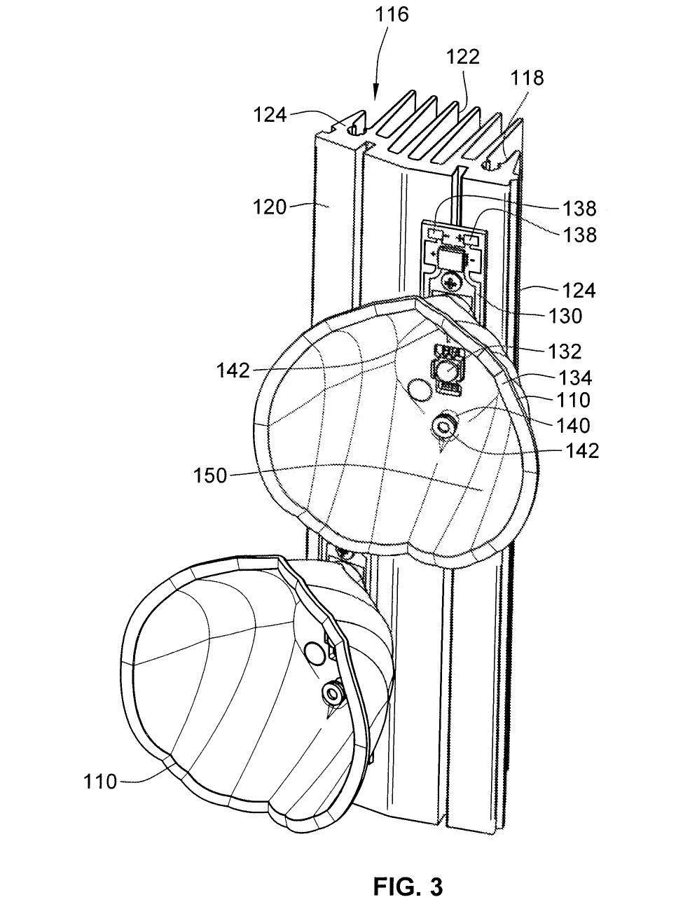

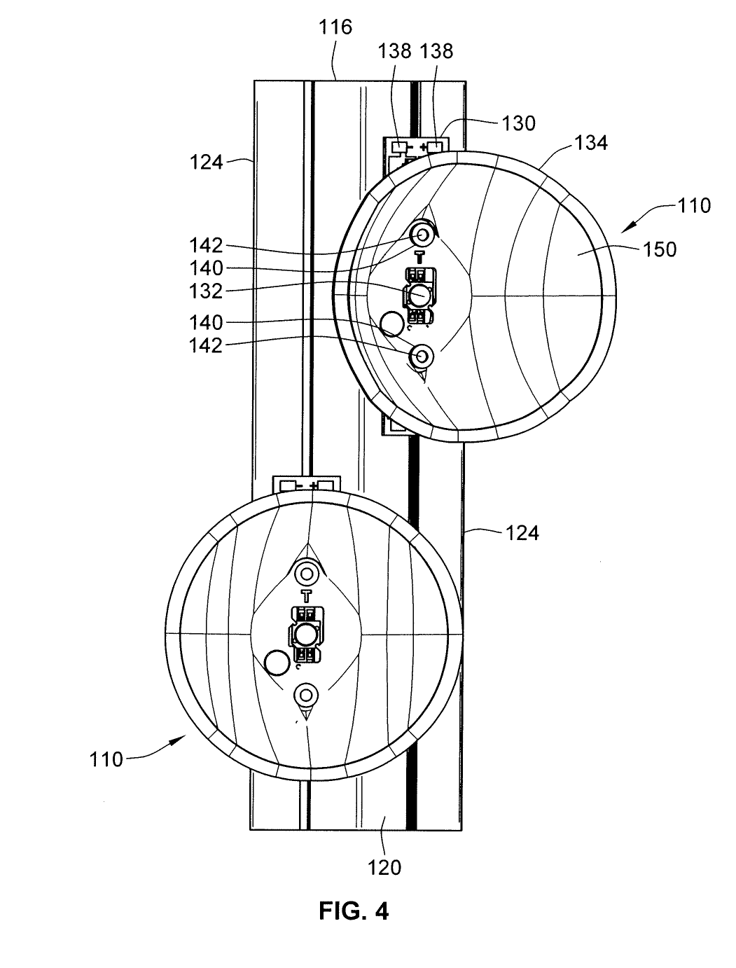

The circular lighting arrays 112 and 114 are constructed from vertical heat sinks 116 mounted radially on the base 102 in FIG. 1. The heat sinks 116 are each an arc segment of the circular lighting arrays 112 and 114. Each of the heat sinks 116 serve as a support member mounted vertically for optical elements 110 as shown in greater detail in FIGS. 3 and 4. FIG. 3 is a perspective view and FIG. 4 is a front view, respectively, of one of the heat sinks 116 that are arranged radially on the base 102 to form the circular lighting arrays 112 and 114 as shown in FIG. 2. As shown in FIGS. 3 and 4, each heat sink 116 has an interior surface 118 and a curved or faceted exterior surface 120. The curved or faceted exterior surface 120 mounts and fixes the optical elements 110. The interior surface 118 has a number of integral fins 122 that serve to dissipate heat generated from the optical elements 110. Each heat sink 116 has sides 124 that interlock with the sides 124 of the adjoining heat sinks 116.

Each of the optical elements 110 have a circuit board 130 mounting an LED 132 with a tulip-shaped reflector 134. As will be detailed below, the reflectors 134 have multiple reflective surfaces 150 and are constructed of molded plastic such as polycarbonate. In this example, the multiple reflective surfaces 150 of the reflectors 134 are coated with a reflective material such as vacuum deposited aluminum with suitable clear protective overcoat material such as SiO₂ or UV-cured polymer.

The LEDs 132 are preferably commercially available “high brightness” light emitting diodes, preferably red, with color chromaticity meeting ICAO and FAA requirements in this example, but other LED types may be used for other applications. The LEDs 132 are attached to the circuit board 130 which, in this example, is a thermally conductive printed circuit board (PCB), preferably having a metal core of aluminum, a thin dielectric layer, and a copper layer defining the electrical pathways. The LEDs 132 are preferably attached using solder, eutectic bonding, or thermally conductive adhesive.

The printed circuit board 130 has wiring attachment points 138 provided for supplying wiring to the electrical components of the printed circuit board 130. The printed circuit board 130 is attached to the heat sink 116 with screws 142 that fix the angular and vertical position of the printed circuit board 130 and corresponding optical element 110 relative to the heat sink 116. The reflector 134 has additional physical registration features such as tabs which allow the reflector 134 to be aligned or centered optically with the LED 132. In this example, mounting screws 142 are inserted through holes 140 in the reflector 134 and the printed circuit board 130 to fix the reflector 134 and the printed circuit board 130 to the heat sink 116.

The heat sink 116 serves to mount and align the circuit board 130 and corresponding LEDs 132 and reflectors 134 of the optical elements 110. The heat sink 116 conducts heat from the LEDs 132 and dissipates the conducted heat through the base 102 shown in FIG. 1. In the preferred embodiment, the heat sinks 116 are aluminum extrusions with the integral fins 122 for heat removal and slot features on each of the adjoining sides 124 to align the heat sinks 116 one to the other to form the circular lighting arrays 112 and 114. In this example, each of the heat sinks 116 mounts an upper and lower optical element 110. Therefore, eleven heat sinks 116 form the circular lighting arrays 112 and 114.

Heat is removed from the LEDs 132 via conduction through the printed circuit boards 130, through conductive grease or adhesive to the heat sink 116. A portion of the heat is conducted through the heat sink to the lower base 102, from which the heat is transferred to the ambient air. Heat may also be transferred from the heat sink integral fins 122 by convection.

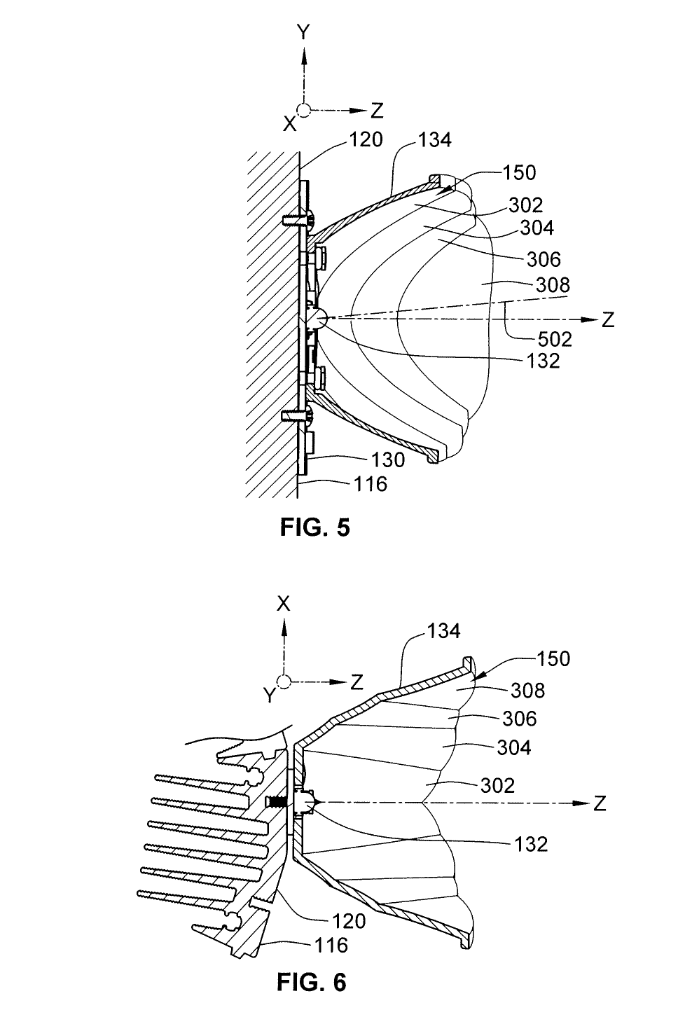

FIGS. 5 and 6 are side and top views respectively of the reflective optical surfaces 150 of the reflector 134. FIG. 5 is a side view showing the vertical cross section of the reflective optical surface 150 of the reflector 134 in FIGS. 2-4. FIG. 5 shows that the Z axis is normal (perpendicular) to the exterior surface 120 of the heat sink 116 corresponding to the plane XY. Therefore, the plane defined by XZ is parallel to the physical horizontal formed by the base 102 of the light lamp 100 in FIG. 1 and the XZ plane is denoted the “physical horizontal plane.” An angle 502 which is 0.25° degrees in this example illustrates that the “horizontal” plane of symmetry of the reflector optical surfaces 150 is offset by a small angle (e.g., 0.25°) from the physical horizontal plane. This angular offset may aim the light beam pattern from the LED 132 and the reflector 134 slightly above the physical horizontal plane in order to better achieve the desired overall beam pattern per ICAO and FAA guidelines. An example range of angular offsets may be from 0-10 degrees. Of course, no angular offset from the horizontal plane may also be used.

FIG. 6 is a top view showing the horizontal cross section of the reflective optical surface of the reflector 134 in FIGS. 2-4. The Z axis is normal (perpendicular) to the exterior surface 120 of the heat sink 116 corresponding to plane XY. As illustrated here, the vertical plane of symmetry of the reflector optical surfaces 150 is coincident with plane ZY. Since the complete light 100 produces light over a full 360°, there is no reason to aim the light beam with any angular offset of the vertical plane of symmetry of the reflector 134.

As shown in FIGS. 5-6, the reflective optical surface 150 has concatenated curved reflective optical surface segments 302, 304, 306 and 308. The reflective optical surface segments 302, 304, 306 and 308 of each individual reflector 134 are optimized for a single LED such as the LED 132. The reflector optical surfaces 302, 304, 306 and 308 are designed to form the vertical (elevation) collimation required to distribute light in very narrow angles in the vertical plane and to distribute light in wide angles via the desired horizontal (azimuth) beam. The reflective optical surface segments 302, 304, 306 and 308 of the reflector optical surface 150 are initially generated by sweeping a polynomial curve along two parabolic curves. The polynomial curve determines how light will be distributed in wide angles, such as the horizontal plane in this example. If the polynomial curve is an arc, the light will be distributed evenly across the range. If the polynomial curve is not an arc such as a curve fitted through control points, the light will be distributed unevenly across the range weighed by the control points. As the segments 302, 304, 306 and 308 are “joined” to form a contiguous optimal surface, neither the segments nor the total reflective surface is amenable to concise mathematical description. As shown in FIGS. 5 and 6, the reflector 134 does have a vertical and horizontal plane of symmetry, but is otherwise non-symmetrical. The segments 302, 304, 306 and 308 therefore create an approximately uniform beam at horizontal angles relative to the reflective surface 150 of the reflector 134 and a narrow beam in vertical angles relative to the reflective surface 150 of the reflector 134.

It is desirable that the beam pattern of light intensity versus elevation is closely matched at all angles of azimuth so that all beams will lie within the allowable “windows” of the ICAO and FAA requirements for this example. Another way of stating this is that a plot of intensity vs. azimuth angle at a fixed angle of elevation should show minimal variation, or “ripple.” “Ripple” is defined as the peak to peak variation in intensity relative to the average intensity at all angles of azimuth.

Minimum ripple has several advantages, it is more feasible to meet the FAA and ICAO requirements and it allows reducing the drive current and/or the number of LEDs needed to achieve minimum intensity at all points.

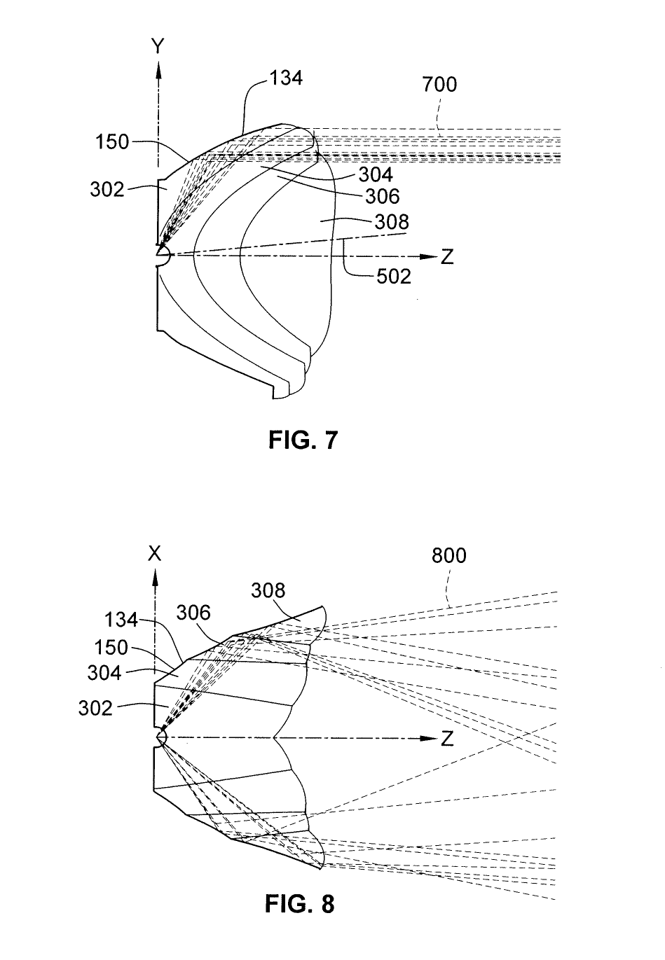

FIG. 7 illustrates a side view of the calculated ray-trace light beams 700 from a single reflector 134 of an optical element 110. The segments 302, 304, 306 and 308 of the reflector optical surface 150 are shown with the horizontal plane of symmetry. The angle 502 which is 0.25° degrees in this example illustrates that the “horizontal” plane of symmetry of the reflector optical surfaces 150 is offset by a small angle (e.g., 0.25°) from the physical horizontal plane. As shown in FIG. 7, the light beams 700 from the segments 302, 304, 306 and 308 create a narrow beam in the vertical angles.

FIG. 8 illustrates a top view of the calculated ray-trace light beams 800 from a single reflector 134 of an optical element 110. The segments 302, 304, 305 and 308 of the reflector optical surface 150 are shown with the vertical plane of symmetry. As shown in FIG. 8, the light beams 800 from the segments 302, 304, 306 and 308 create an approximately uniform beam at horizontal angles.

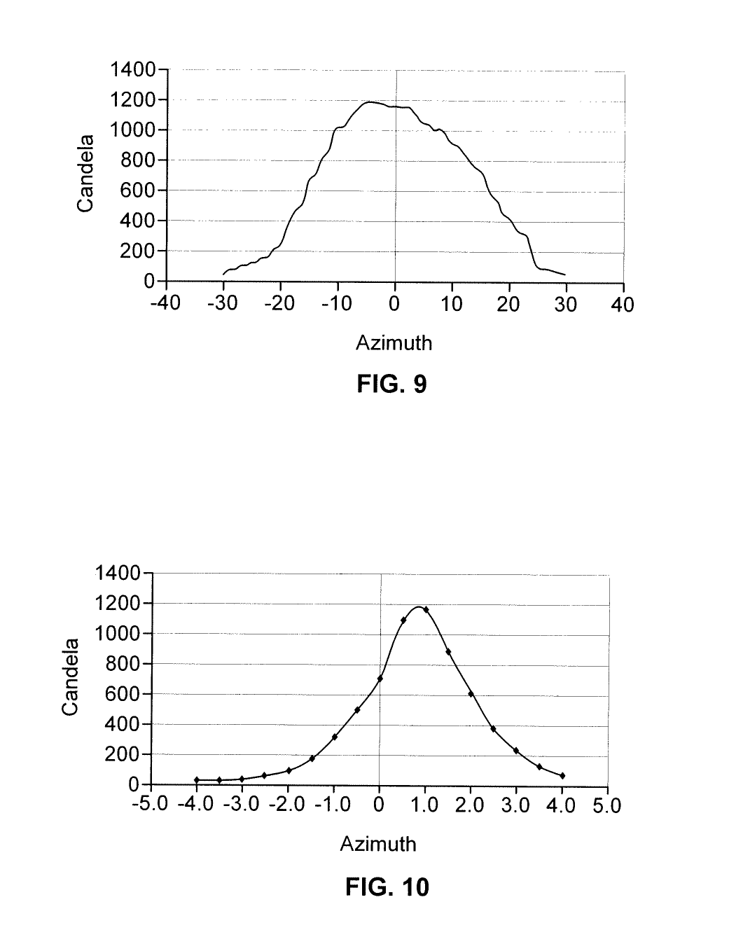

FIG. 9 is a plot of measured intensity from a single LED 132 and tulip-shaped reflector 134 of the optical element 110 in FIG. 3 versus azimuth (horizontal) angle. FIG. 9 shows that the reflector 134 creates a defined broad horizontal beam due to the shape of the segments 302, 304, 306 and 308 of the reflector surface 150.

FIG. 10 is a plot of measured intensity from a single LED 132 and tulip-shaped reflector 134 of the optical element 110 in FIG. 3 versus elevation (vertical) angle. FIG. 10 shows that the reflector 134 creates a narrow beam in vertical directions due to the shape of the segments 302, 304, 306 and 308 of the reflector surface 150.

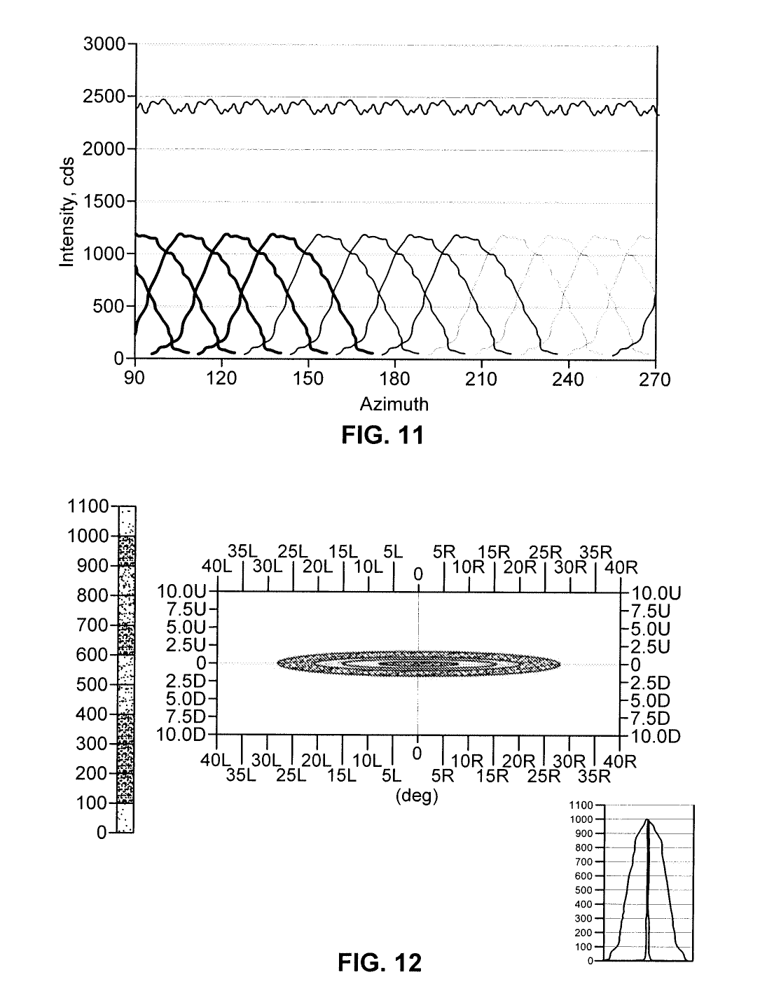

FIG. 11 is a plot of calculated intensity versus the azimuth angle for a summation of measured light intensity from multiple LEDs 132 and reflectors 134 of the optical elements 110 in one of the circular arrays 112 and 114 in FIG. 1. FIG. 11 shows that the multiple LEDs provide a uniform beam intensity with minimal ripple variation for the entire azimuth range.

FIG. 12 is a plot of the calculated far-field intensity pattern in both elevation and azimuth for an optical element 110 in FIG. 3. As shown in FIG. 12, the intensity pattern creates an approximately uniform beam at horizontal angles and a narrow beam in vertical angles.

As shown in FIGS. 9-12, the reflector shapes of the reflectors 134 allow for the use of relatively fewer LEDs and corresponding circuit boards for a high intensity light that allows for 360 degree coverage. The lower relative number of components for sufficient light coverage results in lower energy requirements of the high intensity light 100.

The optical elements 110 could also be modified with other reflector geometry. Further, side-emitting LEDs directed back into a reflector could be used for the optical elements 110. Other reflector designs could be used. For example, a reflector which does not have a horizontal plane of symmetry, if the desired beam pattern were not symmetrical in elevation above and below the horizon (zero elevation) could be used. Alternatively, a reflector in which the horizontal plane of symmetry is not perpendicular to the vertically oriented substrate, if the desired beam pattern is to be directed preferentially above or below the horizon (zero elevation) could be used. The reflectors could also be reflectors combined in groups via molding two or more reflectors. Also, multiple LEDs may be used for each reflector. Staggered TIR optics could be used for the reflectors. Different numbers of LEDs per circular array and different numbers of circular arrays may also be used. An equivalent linear light with similar staggered sources could be used. An electrical control system with adjustable current for each LED or group of LEDs could be used to further reduce variations in beam intensity and uniformity.

Other example applications of the above mentioned concepts include marine navigation lights (e.g., 10 and 15 nautical miles) which require similar beam patterns, other obstruction lights, such as the FAA/ICAO 20,000 cd light, and any other lighting application which similarly requires an energy-efficient, cost-effective LED light with well defined beam pattern. Further, the high intensity optical elements of the high intensity light 100 in FIG. 1 could be modified to emit white light via white light LEDs for daytime operation and include red light LEDs to emit red light for night time operation.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A high intensity light comprising:
a first circular lighting array having a plurality of reflectors and light emitting diodes; and
a second circular lighting array mounted on the first circular lighting array, the second circular lighting array having a second plurality of reflectors and light emitting diodes, and wherein
each reflector includes a reflective surface having a symmetrical vertical cross section and a different symmetrical horizontal cross section to create a uniform beam reflecting from a corresponding LED at horizontal angles relative to the reflective surface and a narrow beam in vertical angles relative to the reflective surface.

2. The high intensity light of claim 1 wherein the second plurality of reflectors and light emitting diodes are offset from the first plurality of reflectors and light emitting diodes of the first circular lighting array.

3. The high intensity light of claim 1 wherein the reflective surface include segments generated as parabolic curves joined to form a contiguous surface.

4. The high intensity light of claim 1 wherein each reflector and light emitting diode is an optical element, the first circular lighting array having eleven optical elements and the second circular lighting array having eleven optical elements.

5. The high intensity light of claim 1 wherein the light emitting diode emits white light.

6. The high intensity light of claim 1 wherein the light emitting diode emits red light.

7. The high intensity light of claim 1 wherein the circular lighting arrays include a plurality of heat sinks arranged radially, the heat sinks including an exterior surface mounting the light emitting diodes and the reflectors and an interior surface.

8. The high intensity light of claim 7, wherein the heat sinks include integral fins protruding from the interior surface.

9. The high intensity light of claim 7, wherein the circular lighting arrays include a printed circuit board mounted on the exterior of the heat sinks for each of the light emitting diodes.

10. The high intensity light of claim 1, wherein each reflector is tilted at a small angle relative to a horizontal plane of the lighting arrays.

11. The high intensity light of claim 1, wherein each reflector includes registration features to align the reflector to the respective LED.

12. An optical assembly for producing a uniform light beam reflected from a corresponding light source at horizontal angles and a narrow beam in vertical angles, comprising:
a support member mounted vertically having an exterior surface;
a light emitting diode mounted on the exterior surface of the support member;
a reflector mounted on the exterior surface of the support member, the reflector having a reflective surface including segments generated as parabolic curves joined to form a contiguous surface, the reflective surface further having a vertical symmetry and a different horizontal symmetry.

13. The optical assembly of claim 12, wherein the light emitting diode emits white light.

14. The optical assembly of claim 12, wherein the light emitting diode emits red light.

15. The optical assembly of claim 12, wherein the reflector is fabricated from molded plastic with a reflective coating.

16. The optical assembly of claim 15, wherein the reflective coating is vacuum deposited aluminum.

17. The optical assembly of claim 12 further comprising a printed circuit board mounted on the exterior surface, the printed circuit board providing power to the light emitting diode.

18. The optical assembly of claim 12, wherein the support member include integral fins protruding from an interior surface opposite the exterior surface.

19. The optical assembly of claim 12, wherein the reflector is mounted at a small angle from a horizontal plane of the support member.

20. The optical assembly of claim 12, wherein the reflector includes registration features to align the reflector to the LED.

21. An aircraft warning lamp comprising:
a first circular lighting array having a first plurality of optical elements emitting light at horizontal angles and a narrow beam in vertical angles;
a second circular lighting array having a second plurality of optical elements emitting light at all horizontal angles and a narrow beam in vertical angles, the second plurality of optical elements being offset from the first plurality of optical elements;
wherein each of the optical elements includes a light emitting diode and a reflector including a reflective surface having a symmetrical vertical cross section and a different symmetrical horizontal cross section to create a uniform beam reflecting from a corresponding light emitting diode at all horizontal angles relative to the reflective surface and a narrow beam in vertical angles relative to the reflective surface.

22. The aircraft warning light of claim 21, wherein the optical element emits white light for daytime operation and wherein the optical elements include a second optical element emitting red light for nighttime operation.

23. The aircraft warning light of claim 21, wherein each reflector is tilted at a small angle relative to a horizontal plane of the lighting arrays.
